(19) United States
(12) Patent Application Publication
(10) Pub. No.: US 2022/0137601 A1
(43) Pub. Date: May 5, 2022

(54) Certificate Management Integrated into a Plant Planning Tool

(71) Applicant: Siemens Aktiengesellschaft, Muenchen (DE)

(72) Inventors: Oliver DRUMM, Eggenstein-Leopoldshafen (DE); Anna PALMIN, Karlsruhe (DE)

(21) Appl. No.: 17/433,297

(22) PCT Filed: Feb. 25, 2020
(86) PCT No.: PCT/EP2020/054838

§ 371 Date: Aug. 24, 2021

(30) Foreign Application Priority Data
Feb. 26, 2019 (EP) 19159450.6

(51) Int. Cl. G05B 19/418; H04L 9/32; H04L 9/00

(52) U.S. Cl. CPC G05B 19/4185; H04L 9/006; H04L 9/3263

(57) ABSTRACT

A method for creating a topology of a technical system, more particularly of a production plant or process plant, with a public key infrastructure via a software tool designed therefor, wherein a plurality of individual components are linked together to form a topology of the technical system, where which certificates needed by the individual components during operation of the technical system is derived from an analysis of security requirements of the technical system in an automated manner and stored in the software tool, where which PKI components and which communication links among the individual components, from the components to the PKI components, and among the individual PKI components, are needed to construct the public key infrastructure is taken into account in an automated manner in the linking of the individual components.

### CROSS-REFERENCE TO RELATED APPLICATIONS

This is a U.S. national stage of application No. PCT/EP2020/054838 filed 25 Feb. 2020. Priority is claimed on European Application No. 19159450.6 filed 26 Feb. 2019, the content of which is incorporated herein by reference in its entirety.

### BACKGROUND OF THE INVENTION

### 1. Field of the Invention

The invention relates to a software tool, a control system and a method for creating a topology of a technical system, in particular of a production plant or process plant, with a public key infrastructure via a software tool designed therefor.

### 2. Description of the Related Art

At present, the planning of a (procedural) plant includes a wide range of trades, the engineering services of which must be coordinated. This process is supported by corresponding planning tools such as the software tool COMOS from SIEMENS. In tools such as this, tender-enabled plant planning is created that is assigned to different trades.

In an integrated planning process, the planning data is then electronically transmitted to the subsequent planning tools, e.g., SIMATIC PCS 7 and SIMIT from SIEMENS. This process is iterative as changes are customary in this phase of plant planning and the data is exchanged in all directions.

Furthermore, the planning tool is used to document the current status of the plant. Changes are also fed back into the planning tool during operation. Maintenance tasks can thus also be scheduled and performed with the planning tool. Communication links between individual plant components are an important component of plant planning.

Due to the requirements of International Electrotechnical Commission (IEC) 62443 (the leading Industrial Security Standard) and the increasing need for protection (due to the increasing use of open IT standards and protocols), the communication links in the control plants must increasingly be secured, i.e., protected against unauthorized access.

In accordance with “Security by Default” as one of the basic principles of the so-called “Charter of Trust”, the automation devices are intended to be able to communicate securely in a procedural plant immediately after being put into operation. This means that most data is to be transmitted in encrypted from the outset. In addition, the integrity and authenticity of the data should be protected by adequate integrity and authentication mechanisms. Such mechanisms are usually part of secure communication protocols (such as Transport Layer Security or TLS or Open Platform Communications Unified Architecture or OPC UA).

The use of secure communication protocols presupposes that the communication subscribers have digital certificates. The certificates that are used in a control plant or in another operational environment to enable secure communication or user authentication, for example, are usually referred to as Operational Certificates, OC. With the increasing number of plant components involved in secure communication relationships and requiring various certificates for various purposes, it is useful to issue the operational certificates for components in an automated manner and assign them to the components.

Such automated certificate management presupposes a public key infrastructure (PKI) that should be present in the respective plant.

### SUMMARY OF THE INVENTION

It is an object of the invention to provide a method for more error-robust, more time-effect certificate management for a technical plant while adhering to the minimality principles.

This and other objects and advantages are achieved in accordance with the invention by a software tool, a control system and a method for creating a topology of a technical system, in particular a production plant or process plant, with a public key infrastructure via a software tool designed therefor.

The object set forth above is achieved by a method for creating a topology of a technical system, in particular of a production plant or process plant, with a public key infrastructure by means of a software tool designed therefor, where a plurality of individual components are linked together to form a topology of the technical system. In one step of the method, information is derived from an analysis of security requirements of the technical system and stored in the software tool. This information includes a statement about which certificates the individual components require during operation of the technical system. When linking the individual components, it is automatically taken into account which public key infrastructure (PKI) components and which communication links are required between the individual components, from the components to the PKI components and between the individual PKI components to establish the public key infrastructure.

A technical system is to be understood here as meaning a plurality of machines, devices or applications, which are functionally and often also spatially related to one another. With the technical system, for example, products or components, can be produced or manufactured in (large) technical dimensions. However, the technical system can also be, for example, an automobile, a ship, or an airplane. The technical system can be, for example, a plant from the process industry such as a chemical, pharmaceutical, petrochemical plant or a plant from the food and beverage industry. However, the term “technical system” also includes any plants from the production industry, plants in which, for example, cars or goods of all kinds are produced. Such technical systems can also come from the field of power generation such as wind turbines, photovoltaic systems, or power stations for generating power.

The term “public key infrastructure” (PKI for short) is associated with a security infrastructure for a technical system that provides services for secure exchange of data between communication partners of the technical system. With the aid of the public key infrastructure, for example, certificates can be issued, distributed, and checked.

A certificate is understood to mean a digital data record that confirms certain properties (in this case, of machines, devices, or applications). The authenticity and integrity of the certificate can be verified via cryptographic methods.

The unique identification can be, for example, a serial number of a plant component. Such a plant component can be, for example, a field device, a control apparatus, or an application.

A topology is understood to mean structural and functional relationships between individual components of the technical system. In the area of process plants, for example, the COMOS software tool from SIEMENS can be used to create a topology of the process plant. In this context, reference is also made to plant planning. Initially, this is abstract planning of the interaction of the various components, without a concrete, physical realization of the individual components being necessary for this. The resulting topology can generally be used to construct the concrete plant. Alternatively or additionally, the results can also be used in the context of a simulation environment for a simulation of the plant, without this actually having to be physically present for this purpose.

In the context of the method in accordance with the invention, security requirements for the technical system or individual components thereof are initially implemented in an automated manner via the software tool. These security requirements can be binding security requirements and results of corresponding security assessments and a “threat and risk” analysis.

From this analysis, the software tool derives which certificates the individual components require. The certificate requests of the components are thus already “mapped out” in the software tool. The individual components, for example, a network switch that has to submit certificate requests for Transport Layer Security (TLS) clients, TLS servers or OPC UA servers, are only assigned the certificate requests that are required for the use of the secure communication protocols or applications needed by the components to perform in the context of the technical system.

This step ensures compliance with the principle of minimality of IT security because the secure communication protocols and the associated types of certificates are only scheduled for the components that they actually need from a security point of view. In accordance with the principle of minimality, no connection to the instances of the public key infrastructure is planned for the components that do not require certificates. This means that even in the event of an unauthorized attempt to apply for a certificate, such a component cannot establish a connection to the public key infrastructure of the technical system because such a connection is not provided in the software tool. In addition, the intended use of each scheduled certificate is severely restricted or precisely tailored to the dedicated task of the respective component.

The information regarding which certificates a certain component can request is stored in the software tool, such as in the form of a configuration file. The software tool does not have to create the configuration file afresh every time the method is cycled through but can also check whether there have been any changes compared to previous versions of the configuration file and then only make the necessary changes.

For security reasons, due to the principle of minimality, the use of a dedicated operational certificate for each utilized communication protocol is recommended. In order to limit the type of certificate required as strictly as possible, in addition to the actual purpose of key usage (which can be stored as an attribute “Key Usage” in the configuration file), it is possible to consider which role (e.g., server or client) a component plays in the context of a specific communication relationship.

For example, if a component uses OPC UA to secure a communication relationship, assumes the server role and uses TLS to secure another communication relationship, it having the client role, then the component requires an OPC UA server certificate and a TLS certificate for the TLS client authentication. This information can be listed in the corresponding certificate application and in the issued certificate based thereon under the attribute “Extended Key Usage”. Both items of information are stored in the configuration file for the relevant component in the software tool.

The attribute “Key Usage” for example, can assume one of the following values, depending on the intended use:
Data Encipherment
Key Encipherment
Key Agreement
Digital Signature

The further ascertainment of the intended purpose is then realized by the attribute “Extended Key Usage”. This attribute can, for example, assume the following values:
TLS Server Authentication
TLS Client Authentication
OPC-UA Server Authentication
Digital Signature

Within the scope of the method in accordance with the invention, the software tool also automatically takes into account which PKI components and which communication links are required between the individual components, from the components to the PKI components and between the individual PKI components to establish the public key infrastructure.

At least one registration authority (RA), one issuing certification authority (CA) and one software database are required to establish a public key infrastructure in a manner known per se. In addition, further PKI components, such as local registration authorities (LRA), can be included in the public key infrastructure. A registration authority of the technical system is understood to mean a functional entity that accepts registration requests, such as certificate requests from components of the technical system, checks these and, if successful, forwards them in particular to an issuing certification authority of the technical system.

The software tool also automatically creates the necessary communication links between the (normal) components of the technical system and the (special) PKI components. For example, certain components of the technical system can be automatically assigned to individual RAs or LRAs. The connected communication network is determined based on each component that has been found to be required for certain types of certificates. As the entire system network forms a graph, known algorithms from graph theory can be used to determine the communication paths between the components (e.g., breadth-first search or depth-first search). If the communication paths are known via graph-theoretical investigations, it can be determined automatically therefrom which partners can in principle exchange via which communication protocols.

Before the created topology is used for other purposes (concrete implementation of the technical system and/or simulations), the user can advantageously make changes or modifications to the topology within the software tool.

With the method in accordance with the invention, it is possible to ensure a particular component of a technical system which does not need certain certificates at all also cannot receive (and possibly misuse) these unneeded certificates. As a result, a sound contribution is made to compliance with the principle of minimality (required by NAMUR, inter alia). In addition, a contribution is made to eliminating errors and reducing the time required to assign individual certificates or types of certificates to the individual components.

Within the scope of an advantageous embodiment of the method, the software tool is used to check whether the individual components are established for use of the certificates required in each case. In the event that a component is not established for use of a required certificate, the software tool either replaces the relevant component in the topology automatically with a suitably configured component or submits a proposal for such a replacement to a user of the software tool.

The software tool preferably transmits information about which certificates the individual components require during operation of the technical system to a software database of a control system of the technical system.

In the present context, a control system is understood to be a computer-aided, technical system that includes functionalities for displaying, operating, and guiding, for example, a technical manufacturing or production plant. Here, the control system comprises sensors for determining measured values and various actuators. In addition, the control system comprises “process or production-related” components that are used to control the actuators or sensors. Furthermore, the control system has, inter alia, means for visualizing the technical plant and engineering. In addition, the term control system also includes further processing units for more complex adjustments and systems for data storage and processing. In the present case, the control system has a software database for storing information relating to the certificates required by individual components.

An advantage resulting from this development of the method is that the security of the technical system or the public key infrastructure can be further increased. If a component has passed the first hurdle of basic purchase authorization, then the component encounters a second security check that queries the authorizations of the respective component as a function of the type of certificate to be obtained.

It is also an object of the invention to provide a software tool which is configured to perform the method in accordance with the disclosed embodiments.

It is a further object of the invention to provide a control system for controlling a technical system, in particular, a process plant or production plant. The control system comprises at least one software tool and one software database. The software database is configured for a public key infrastructure of a technical system, in particular, a production plant or a process plant, where the technical system comprises at least one unambiguous identification of components included in the technical system. In the software database, information is stored for at least one component for which an unambiguous identification is stored in the software inventory as to whether certificates may be assigned to the component.

The software database contains at least one item of information about whether certificates may (or may not) be assigned to a particular component of the technical system (at all). Even if the component concerned succeeds in submitting a certificate request to the registration authority of the public key infrastructure without authorization, the information stored in the software database about the authorizations of the individual components provides an additional level of security for the public key infrastructure of the technical system.

In order to further increase security, information about which certificates may be assigned to a respective component can be stored in the software database for at least one component, if appropriate. In other words, not only is a “whitelist” stored in the software database, which indicates which components may obtain certificates at all, but also a list of certificates that the “authorized” components may obtain. If a component has passed the first hurdle of basic purchase authorization, then the component encounters a second security check that queries the authorizations of the respective component as a function of the type of certificate to be obtained.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic illustration of a control system of a procedural plant shown in accordance with the invention; and

FIG. 2 is a flowchart of the method in accordance with the invention.

### DETAILED DESCRIPTION OF THE EXEMPLARY EMBODIMENTS

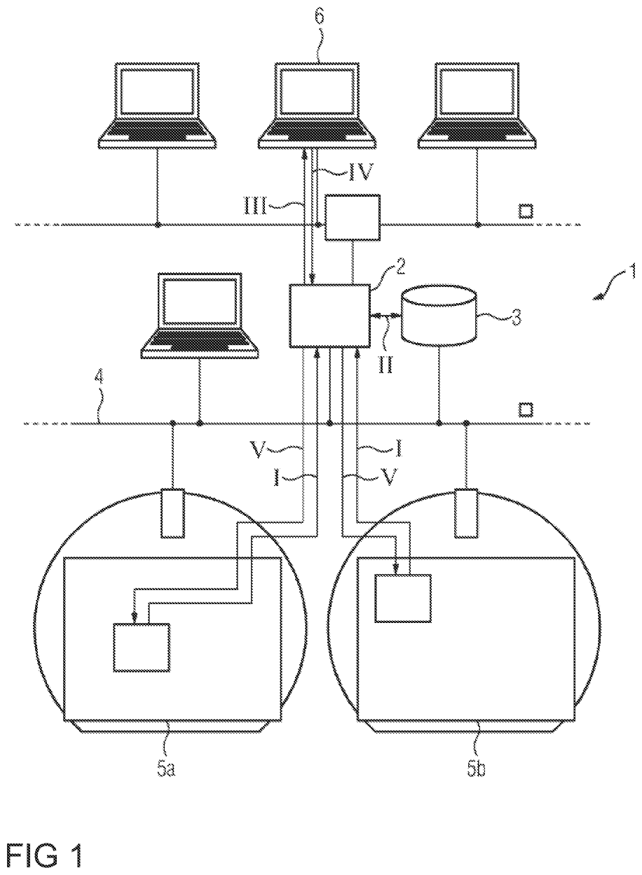

A simplified embodiment of a public key infrastructure is explained via a part of a control system 1 of a procedural plant shown in FIG. 1. The control system 1 has a registration authority 2 and an inventory 3.

The control system 1 is connected via a plant bus 4 to devices/components 5a, 5b of a procedural plant. The devices 5a, 5b may also be applications, in particular, web applications. Within the scope of the invention, any number of devices and/or applications can be connected to the control system 1. The plant bus 4 can, without limitation, for example, be configured as an Industrial Ethernet.

As part of certificate management, in a first step I, the two devices 5a, 5b submit certificate requests that are directed to the registration authority 2. In a second step II, the registration authority 2 checks, in consultation with the inventory 3, whether the respective device 5a, 5b is allowed to receive the certificate at all.

In the subsequent third step III, the registration authority 2 forwards the certificate requests to an issuing certification authority 6 (CA) of the procedural plant, where the forwarded certificate requests are provided with a secret key of the registration authority 2. The issuing certification authority 6 checks the signature on the certificate requests using the public key of the registration authority 2 available to it. The issuing certification authority 6 then creates the requested certificates and forwards them to the registration authority 2 in a fourth step IV. The registration authority 2 checks the validity of the certificates received and then, in a final fifth step V, forwards the received certificates to the devices 5a, 5b that have submitted the certificate requests.

If a control plant (e.g., in accordance with the SIMATIC PCS 7 Security Concept from SIEMENS) is heavily segmented and consists of a plurality of independently functioning and secured security cells that are separated from one another by firewalls, then it is advisable to install a Local Registration Authority (LRA) in each security cell as a registration authority, where the authority forwards the certificate requests to an issuing certification authority that is accessible to all Local Registration Authorities.

The procedures for applying for the certificates by plant components and for the subsequent delivery of the certificates to the devices require communication links between various PKI instances and plant components. The plant planner only determines the functional communication links via plant planning. The protocols used to secure them, and the associated certificates are not planned. The public key infrastructure required to issue the certificates is also not taken into account in the planning.

When commissioning in the customer system, the service technician is then, on the one hand faced, with the task of determining (or guessing) which certificates the plant components require for the purpose of realizing secure communication links. On the other hand, he must define and implement the communication paths via which the components are to obtain the certificates from the PKI of the plant. As already explained, the communication paths can run via a plurality of local registration authorities or registration authorities to one or more certification authorities.

It has frequently been found that a component scheduled by the planner during plant planning does not support the secure type of communication selected by the service technician and thus the certificate required therefor at all. For example, currently only some selected “industrial controllers” can transmit the detected log information to a central Syslog server or a central Security Information and Event Management (SIEM) system via “Secure Syslog”. They use the required TLS certificates for this. If an incompatible industrial controller (without Secure Syslog/TLS) is scheduled in the plant planning, a service technician cannot later implement a secure communication link to a central Syslog server/SIEM system. If, however, the secure communication is necessary from a security point of view, the industrial controller must be replaced by a suitable controller afterwards.

Furthermore, it often proves necessary to extend the network planning performed by the plant planner via the communication links between the plant components and the PKI instances. For the retrospective incorporation of such changes into the original plant planning and the associated planning documentation, there is currently no adequate instrument. Thus, the planning documentation frequently does not correspond to the reality and cannot be used as a basis for the planning and performance of maintenance tasks.

According to the underlying PKI concept (see the description above and FIG. 1), an important prerequisite for standard certificate management is that all components that are allowed to receive certificates are listed in an inventory. As of today, all “legitimized” plant components are stored in the inventory that have successfully proven their originality (in an earlier step, for example, in incoming goods) with the aid of a Manufacturer Device Certificate (MDC).

In principle, every “legitimized” component can thus apply for any certificate (inter alia, a certificate with a plurality of intended uses) via the registration authority. As the registration authority only checks whether the component is legitimized in principle, it will deem the certificate application valid and forward it to an issuing certification authority of the procedural plant. However, this enables the plant components to receive certificates that they do not require or are not allowed to have at all, which is highly critical from a security point of view.

If, for example, user access to the web server of a controller via Hypertext Transfer Protocol Secure (HTTPS) is not scheduled and is even necessarily to be prevented from a security point of view, then the controller should not (be allowed to) receive a TLS web server certificate. The use of certificates with a plurality of intended uses is highly critical from a security point of view. Although such a certificate enables the use of a plurality of secure protocols in a purely functional manner and serves as a substitute for a plurality of dedicated certificates for different intended uses, on the one hand, it can be misused for the use of unauthorized communication links.

It should also be noted that if such a certificate has been compromised (i.e., if the private key was determined by an attacker), all communication links protected by the certificate (more precisely, by the associated compromised private key) are compromised. A violation of the principle of minimality is associated with the problems described above. This means that only as many communication links may be used as are necessary and, from a security point of view, permissible.

The planning of certificate management is not a constituent part of the integrated engineering of a procedural plant today. This means, in particular, that the planning of the necessary communication links, i.e., the communication paths via which the certificates are to be obtained from a trustworthy issuing certification authority of the plant, and the planning of the relevant types of certificate required for individual components and the certificate contents (in particular, the intended use) occur completely independently of one another, which is usually associated with the above-explained problems and with a high level of additional effort.

The planning of certificate contents usually occurs arbitrarily and without any specifications because, primarily, simple functioning is paramount. In particular, this leads to the certificate contents being defined in a generalized manner so that a certificate can be used for different intended uses. From a security point of view, however, this is at least not recommended or even permissible.

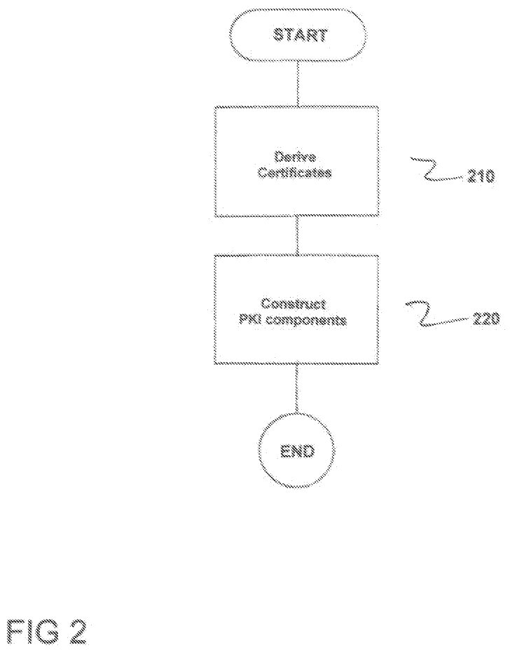

If the certificate contents are not planned in a generalized manner, errors usually occur. For example, “TLS Server Authentication” is often accidentally selected instead of “TLS Client Authentication” for the attribute “Extended Key Usage”. If such a certificate is applied for correctly, is issued by the issuing certification authority and is assigned to a component with the role of “web client” via the registration authority, this leads to a failed authentication when using the certificate during a TLS handshake because the communication partner of the components with the role of “web server” is expecting a web client certificate (with the “TLS Client Authentication” as “Extended Key Usage”). FIG. 2 is a flowchart of the method for creating a topology of a technical system with a public key infrastructure (PKI) via a software tool configured therefor, a plurality of individual components 5a, 5b being linked together to form a topology of the technical system. The method comprises deriving which certificates the plurality of individual components 5a, 5b need during operation of the technical system from an analysis of security requirements of the technical system in an automated manner and storing the derived certificates in the software tool, as indicated in step 210.

Next, which PKI components 2, 6 and which communication links among the plurality of individual components, from the plurality of individual components 5a, 5b to the PKI components 2, 6 and among the individual PKI components 2, 6, are needed to construct the public key infrastructure in an automated manner in the linking of the plurality of individual components 5a, 5b are taken into account, as indicated in step 220.

FIG. 2 is a flowchart of a method for creating a topology of a technical system with a public key infrastructure (PKI) via a software tool configured therefor, a plurality of individual components 5a, 5b being linked together to form a topology of the technical system. The method comprises deriving which certificates the plurality of individual components 5a, 5b need during operation of the technical system from an analysis of security requirements of the technical system in an automated manner and storing the derived certificates in the software tool, as indicated in step 210.

Next, the public key infrastructure is constructed in an automated manner when linking the plurality of individual components 5a, 5b based on which PKI components 2, 6 and which communication links among the plurality of individual components, from the plurality of individual components 5a, 5b to the PKI components 2, 6 and among the individual PKI components 2, 6, are needed, as indicated in step 220.

In addition to simplifying certificate management, greater transparency and better auditability and traceability of the technical system can be achieved through the central storage of the certificates for the respective components in the software database.

Although the invention has been illustrated and described in detail by preferred exemplary embodiments, the invention is not limited by the disclosed examples and other variations can be derived therefrom by a person skilled in the art without departing from the scope of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A method for creating a topology of a technical system with a public key infrastructure via a software tool configured therefor, a plurality of individual components being linked together to form a topology of the technical system, the method comprising:
deriving which certificates the plurality of individual components need during operation of the technical system from an analysis of security requirements of the technical system in an automated manner and storing the derived certificates in the software tool; and
constructing the PKI in an automated manner when linking the plurality of individual components based on which PKI components and which communication links among the plurality of individual components, from the plurality of individual components to the PKI components and among the individual PKI components, are needed.

7. The method as claimed in claim 6, wherein said deriving comprising checking via the software tool whether the plurality of individual components are configured for use of respectively required certificates; and
wherein the software tool one of (i) replaces the relevant component in the topology automatically with a suitably designed component and (ii) submits a proposal for such a replacement to a user of the software tool in an event a component of the plurality of individual components is not configured for use of a required certificate.

8. The method as claimed in claim 6, further comprising:
transmitting, by the software tool, information about which certificates the plurality of individual components require during operation of the technical system to a software database of a control system of the technical system.

9. The method as claimed in claim 7, further comprising:
transmitting, by the software tool, information about which certificates the plurality of individual components require during operation of the technical system to a software database of a control system of the technical system.

10. The method of claim 6, wherein the method is performed by a software tool.

11. The method as claimed in claim 6, wherein the technical system comprises one of (i) a production plant and a process plant.

12. A control system for controlling a technical system having a software tool and a software database which is configured for a public key infrastructure of the technical system, the control system comprising:
a processor; and
memory;
wherein the technical system comprises:
at least one unambiguous identification of components included in the technical system, and to which a registration authority of the public key infrastructure has at least read access; and
wherein information is stored in the software database for at least one component for which an unambiguous identification is stored in the software database as to whether certificates may be assigned to the component.

13. The method as claimed in claim 6, wherein the technical system comprises one of (i) a production plant and a process plant.
